(19) United States
(12) Patent Application Publication
(10) Pub. No.: US 2025/0129210 A1
(43) Pub. Date: Apr. 24, 2025

(54) BRANCHED POLYETHYLENE WITH IN-CHAIN KETONES

(71) Applicant: REGENTS OF THE UNIVERSITY OF MINNESOTA, Minneapolis, MN (US)

(72) Inventors: Ian Albert Tonks, Minneapolis, MN (US); Shao-Yu Lo, Minneapolis, MN (US)

(21) Appl. No.: 18/916,899

(22) Filed: Oct. 16, 2024

Related U.S. Application Data
(60) Provisional application No. 63/544,686, filed on Oct. 18, 2023.
(60) Provisional application No. 63/604,510, filed on Nov. 30, 2023.

(51) Int. Cl. C08G 67/02; C08K 5/00

(52) U.S. Cl. CPC C08G 67/02; C08K 5/0091

(57) ABSTRACT

Polymers polymerized from an alpha-olefin monomer and a carbon monoxide monomer. The polymers include a carbon-based backbone formed from carbons of the alpha-olefin monomer and the carbon of the carbon monoxide monomer. The polymer includes in-backbone ketones formed from the carbon monoxide monomer. The in-backbone ketones may include isolated ketones, alpha-branched ketones, or both. Methods of forming the polymer and compositions containing the polymer.

### CROSS-REFERENCE TO RELATED APPLICATION

This application claims the benefit of U.S. Provisional Patent Application No. 63/544,686, filed on Oct. 18, 2023, and U.S. Provisional Patent Application No. 63/604,510, filed on Nov. 30, 2023, each of which are incorporated herein by reference in its entirety.

### GOVERNMENT FUNDING

This invention was made with government support under DE-SC0020214 awarded by the Department of Energy. The government has certain rights in the invention.

### SUMMARY

This disclosure describes, in one aspect a polymer polymerized at least from alpha-olefine monomers and carbon monoxide monomers. The polymer includes a carbon-based backbone formed from at least a portion of the carbons of the alpha-olefins monomer and at least a portion of the carbons of the carbon monoxide monomers. The polymer includes in-backbone ketones formed from the carbon monoxide monomers. The in-backbone ketones may be isolated ketones or alpha-branched ketones. The polymer can include isolated ketones, alpha-branched ketones, or both.

In one or more embodiments, the alpha-olefine monomers include a single alpha-olefine monomer; that is, all of the alpha-olefin monomers are of the same identity. In one or more embodiments, the alpha-olefin monomers include two or more alpha-olefin monomers of different identities. In one or more embodiments, the alpha-olefin monomers include hexene, octene, decene, or any combination thereof.

In one or more embodiments, the alpha-branched ketones include alpha-methyl-branched ketones, alpha-alkyl-branched ketones, or both.

In one or more embodiments, the alpha-olefine monomers comprise linear alpha-olefin monomers. In one or more embodiments, the linear alpha-olefin monomer includes a C3 to C30 linear alpha-olefine monomer.

In one or more embodiments, the polymer is degradable. In one or more embodiments, the polymer is photodegradable.

In one or more embodiments, the polymer has a thermal melting temperature of 50° C. to 150° C.

In one or more embodiments, the polymer has a CO to alpha-olefin ratio of 1 alpha-olefin per CO to 150 alpha-olefins per CO. In one or more embodiments, the polymer has a mol-% CO calculated relative to alpha-olefin units of 0.01 mol-% to 30 mol-%, wherein 100 mol-% is the sum of the mol-% CO and the mol-% alpha-olefin. In one or more embodiments, the polymer has a mol-% CO calculated relative to alpha-olefin units of 0.01 mol-% to 15 mol-%, wherein 100 mol-% is the sum of the mol-% CO and the mol-% alpha-olefin. In one or more embodiments, the polymer has a mol-% CO calculated relative to ethylene unit equivalents of 0.01 mol-% to 15 mol-%. In one or more embodiments, the polymer has a branching density of 1 branch per 1000 carbons to 60 branches per 1000 carbons. In one or more embodiments, the polymer has an alpha-methyl-branched ketone to alpha-alkyl-branched ketone ratio of 0.01 alpha-methyl-branched ketones per every alpha-alkyl-branched ketone to 10 alpha-methyl-branched ketones per every alpha-alkyl-branched ketone.

In another aspect, the present disclosure describes a composition that includes the polymer of any of the preceding aspects or embodiment. In one or more embodiments, the composition is a lubricant composition.

In another aspect, the present disclosure describes a method of making the polymer of the preceding embodiments or aspects. The method includes exposing a liquid containing reaction mixture to gaseous carbon monoxide, the reaction mixture comprising the alpha-olefin monomers, a catalyst, and a solvent.

In one or more embodiments, the liquid containing reaction mixture is exposed to gaseous carbon monoxide at a pressure of 10 atm (1013 kPa) or less.

In one or more embodiments, the catalyst is a diimine late transition metal catalyst.

In one or more embodiments, the liquid containing reaction mixture comprises an additive and the additive comprises a tetraarylborate.

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a proposed synthetic scheme and mechanism for synthesizing polymers consistent with embodiments of the present disclosure.

FIG. 2 shows polymer characterization data for polymers copolymerized from carbon monoxide (CO) and a hexene monomer, CO and an octene monomer, or CO and a decene monomer under the conditions of the reaction scheme shown. ^{a}4.3 mol-% of CO to hexene insertion (equal to 1.4 mol-% and 1.4 wt-% CO in ethylene polymerization). ^{b}5.2 mol-% CO to octene insertion (equal to 1.3 mol-% and 1.3 wt-% CO in ethylene polymerization). iPr is isopropyl and Me is methyl.

FIG. 3 shows the structures of (L1)PdMeCl, (L2)PdMeCl, (L3)PdMeCl, (L4)PdMeCl, and (L5)PdMeCl catalysts. iPr is isopropyl, Me is methyl, and Ph is phenyl.

FIG. 4 shows polymer characterization data for polymers copolymerized from carbon monoxide and either octene or decene using various catalysts. “c” indicates the value was determined using ¹H NMR.

FIG. 5 is a ¹³C NMR spectrum and inlay of a polymer copolymerized from ¹³CO and an octene monomer. The structures for a non-branched ketone (isolated carbonyl), methyl branched ketone, and longer branched ketone are also shown.

FIG. 6 shows polymer characterization data for polymers copolymerized from carbon monoxide and an octene monomer or decene monomer under the conditions of the scheme shown.

FIG. 7 is a schematic showing possible mechanisms by which alkyl polymer branches may be formed.

FIG. 8 is a schematic showing possible mechanisms by which alkyl polymer branches may be formed.

### DETAILED DESCRIPTION OF ILLUSTRATIVE EMBODIMENTS

Poly(ethylene), a polymer having C₂H₄ repeating groups, is a common plastic used in various consumer goods including plastic tubes, plastic furniture, plastic bags, plastic bottles, plastic films, and the like. There are subtypes of poly(ethylene), each subtype having a particular molecular architecture and properties. Three of the most common poly(ethylene) subtypes are high-density poly(ethylene) (HDPE), low-density poly(ethylene) (LDPE), and linear low-density poly(ethylene) (LLDPE). HDPE is a linear ethylene homopolymer having a high degree of crystallinity and high strength. LDPE is an ethylene homopolymer that includes both short chain branches and long chain branches, the branches contributing to the flexibility of the material. LLDPE has similar properties to LDPE but is made from ethylene and one or more longer chain alpha-olefins (e.g., 1-butene, 1-hexene, and 1-octene). LLDPE has many short chain branches.

Although poly(ethylene) is highly used, its construction of inert hydrocarbon chains, makes it challenging to break down once discarded. The transformation of poly(ethylene) into a photodegradable material, while preserving its physical properties, may be achieved by incorporating ketones into the poly(ethylene) backbone. Ketones can be incorporated via the inclusion of carbon monoxide (CO) in the polymerization reaction. Existing methods for synthesizing poly(ethylene) with in-chain ketones typically rely on customized ethylene/CO gas mixtures, involve harsh reaction conditions, or both. Additionally, some conventional methods use highly optimized catalysts to allow ethylene to be incorporated efficiently into a polymer without too much CO incorporation.

In contrast to existing methods, the present disclosure describes a method of using long chain alpha-olefin (α-olefin) monomers and low pressures of CO for synthesizing a polymer similar to polyethylene having in-chain ketone. Additionally, the present disclosure describes branched poly(alpha-olefin) polymer having in-chain ketones. By introducing branches into the backbone, the polymer physical properties may be tuned to mimic, for example HDPE, LDPE, or LLDPE. Additionally, the inclusion of in-chain ketones may make the polymer photodegradable.

The present disclosure describes a polymer. Polymers are polymerized from one or more monomers. A polymer polymerized from a particular monomer may be described as “monomer name” polymer or poly(“monomer name”). A polymer polymerized from two monomers may be described as “first monomer name”/“second monomer name,” polymer; poly(“first monomer name”/“second monomer name”) polymer; or poly(“first monomer name”) that includes a “functional group name” where the functional group is formed from the second monomer.

In one aspect, the present disclosure describes a polymer having a carbon-based backbone, one or more carbon-based branches, and one or more in-chain ketones. A backbone is the longest continuous chain in a molecule. A branch is a chain that is shorter than the backbone chain and extends from the backbone chain or extends from another branch. A backbone or branch that is carbon-based is characterized by carbon-carbon bonds defining the length of the chain.

The polymer of the present disclosure is polymerized from carbon monoxide (CO) and at least one alpha-olefin monomer. The carbon-based backbone and carbon-based branches are formed from the carbons of the alpha-olefin monomers and the carbon of the CO. As such, the polymer may be described as a branched poly(alpha-olefin) polymer having one or more in-chain ketones. Stated differently, the present disclosure describes a branched poly(alpha-olefin/CO) polymer. Stated yet again another way, the present disclosure describes a polymer polymerized from an alpha-olefin monomer and CO. The polymers of the present disclosure may be described as poly(ethylene) polymers because although not polymerized from ethylene, the polymers include C₂H₄ and CH(R)CH₂ repeating groups where R is a branch, similar to LLDPE and/or LDPE depending on the branch length.

The polymer is polymerized from CO and at least one alpha-olefin monomer. An alpha-olefin is an alkene where the double bond is a terminal double bond. In one or more embodiments, the alpha-olefin is a hydrocarbon; that is, includes only C—C and C—H bonds. In one or more embodiments, the alpha-olefin is a linear alpha-olefin; that is, the alpha-olefin has no branches. In one or more embodiments, the alpha-olefin is a hydrocarbon linear alpha-olefin. An alpha-olefin that may be used to form a polymer of the present disclosure may be a C3 to C30 alpha-olefin (e.g., a C3, C4, C5, C6, C7, C8, C9, C10, C11, C12, C13, C14, C15, C16, C17, C18, C19, C20, C21, C22, C23, C24, C25, C26, C27, C28, C29, or C30 alpha-olefin). Examples of alpha-olefins that may be used to form the polymers of the present disclosure include, but are not limited to the, butene, pentene, hexene, heptene, octene, nonene, decene, undecene, dodecene, tridecene, tetradecene, pentadecene, hexadecene, heptadecene, octadecene, nonadecene, icosene, heneicosene, docosene, tricosene, and tetracosene. Examples of linear alpha-olefins that may be used to form the polymers of the present disclosure include, but are not limited to the, n-butene, n-pentene, n-hexene, n-heptene, n-octene, n-nonene, n-decene, n-undecane, n-dodecene, n-tridecene, n-tetradecene, n-pentadecene, n-hexadecene, n-heptadecene, n-octadecene, n-nonadecene, n-icosene, n-heneicosene, n-docosene, n-tricosene, and n-tetracosene.

In one or more embodiments, the polymer is polymerized from CO and a C3 to C24 alpha-olefin, CO and a C6 to C24 alpha-olefin, or CO and a C6 to C10 alpha-olefin. In one or more embodiments, the polymer is polymerized from CO and a hydrocarbon linear C3 to C24 alpha-olefin, CO and a linear C6 to C24 alpha-olefin, or CO and a linear C6 to C10 alpha-olefin. In one or more embodiments, the polymer is polymerized from CO and 1-hexene, 1-octene, or 1-decene.

In one or more embodiments, the polymer is polymerized from CO and two or more alpha-olefins.

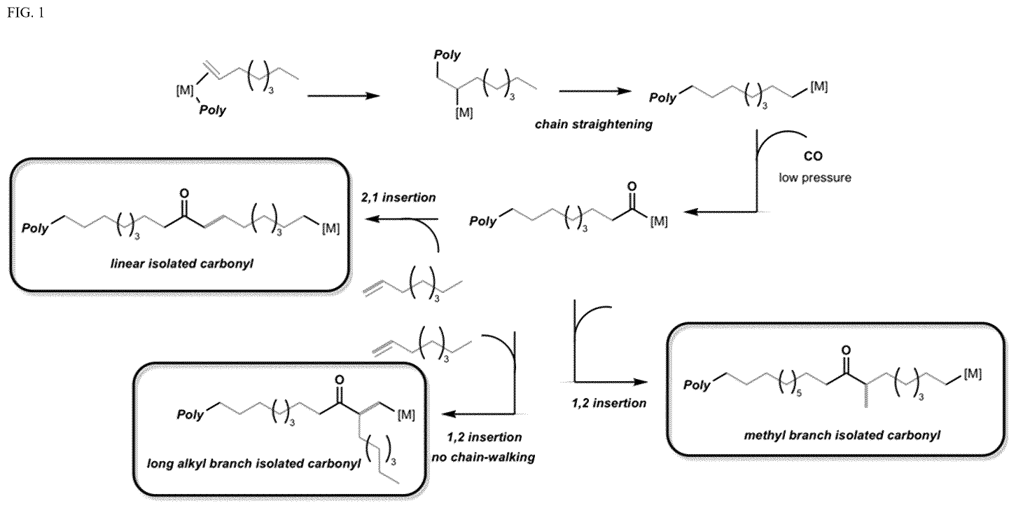

The polymer includes one or more in-chain ketones (—C(O)—). An in-chain ketone is a ketone where the carbon of the ketone lies within a carbon-based chain of the polymer; that is, the carbon of the ketone is a part of the carbon-based chain. In one or more embodiments, the in-chain ketone is an in-backbone ketone; that is, the carbon of the ketone is a part of the polymer backbone. The in-chain ketone may be covalently bonded to a carbon of a first alpha-olefin monomer and a carbon of a second alpha-olefin monomer or the polymer. In-chain ketones may be formed by the insertion of carbon monoxide into the growing polymer chain (See FIG. 1).

In one or more embodiments, the polymer includes non-alternating in-chain ketones. In the context of the present disclosure, non-alternating in-chain ketones are in-chain ketones that are separated along a chain by more than one alpha-olefin alkene unit (—CH₂CH₂—). In one or more embodiments, the non-alternating in-chain ketones may be in-backbone ketones. In one or more embodiments, the polymer includes in-chain alternating ketones. The in-chain alternating ketones may be in-backbone ketones. In one or more embodiments, the polymer includes non-alternating ketones and alternating ketones. In one or more embodiments, the polymer includes non-alternating in-backbone ketones and alternating in-backbone ketones.

In one or more embodiments, the number of in-chain alternating ketones in the polymer based on the total number of in-chain ketones in the polymer is 0% or greater, 1% or greater, 2% or greater, 3% or greater, 4% or great, 5% or greater, 10% or greater, 20% or greater, 30% or greater, or 40% or greater. In one or more embodiments, the number of in-chain alternating ketones in the polymer based on the total number of in-chain ketones in the polymer is 50% or less, 40% or less, 30% or less, 20% or less, 10% or less, 5% or less, 4% or less, 3% or less, 2% or less, or 1% or less, In one or more embodiments, the number of in-chain alternating ketones in the polymer based on the total number of in-chain ketones in the polymer is 0% to 20% such as 0% to 10% or 0% to 5%.

The polymer includes a plurality of branches. A branch is covalently bonded to and extends from a backbone the polymer or another branch. In the context of the polymers of the present disclosure, a branch is formed from at least a portion of an alpha-olefin monomer. In one or more embodiments, a branch is formed from at least a portion of one alpha-olefin monomers. In one or more embodiments, a branch is formed from at least a portion of one or more alpha-olefin monomers.

A branch may have a variety of lengths. The length of a branch may be at least partially dependent on the identity of the one or more alpha-olefin monomers from which it is formed. When considering the length of a branch, only carbons that are not a part of the polymer backbone from which a branch extends, or not a part of the branch from which a second branch extends, are considered. A branch has a length of C1 or greater up to the number of carbons in the polymer backbone chain. In one or more embodiments, a branch has a length of C1 to C30 (e.g., C1, C2, C3, C4, C5, C6, C7, C8, C9, C10, C11, C12, C13, C14, C15, C16, C17, C18, C19, C20, C21, C22, C23, C24, C25, C26, C27, C28, C29, or C30). In one or more embodiments, a branch has the length of the alpha-olefine monomer from which it was formed.

The length of the branches can affect the properties of the polymer. For example, a polymer with few or many long branches may have properties similar to LDPE. A polymer with few or many short branches may have properties similar to LLDPE. In one or more embodiments, the polymer includes branches of C1 to C20, such as C1 to C10, or C1 to C8.

In one or more embodiments, the polymer includes one or more methyl branches. A methyl branch is a branch having a length of C1. A methyl branch may be formed from 1,2-insertion of the alpha-olefin monomer into the growing polymer chain (See FIG. 1, “methyl branch carbonyl”).

In one or more embodiments, the polymer includes one or more alkyl branches. An alkyl branch has a length greater than C1 and optionally includes one or more in-chain ketones, one or more branches extending from the alkyl branch, or both. In one or more embodiments, an alky branch does not include an in-chain ketone. In one or more embodiments, an alky branch does not include a branch extending from the alkyl branch. In one or more embodiments, an alkyl branch has a length of at least 2 carbons less than the alpha-olefine from which it was formed. For example, an alkyl branch formed from a C8 alpha-olefine monomer may have a length of C6, C5, C4, C3, or C2. In one or more embodiments, an alkyl branch has a length of two fewer carbons than the linear alpha-olefin used to form the branch. For example, a C6 alkyl branch may have been formed from a linear C8 alpha-olefin monomer. An alkyl branch may be formed from the 1,2-insertion of the alpha-olefin monomer into the growing polymer chain (see FIG. 1; “long alkyl branch carbonyl”).

In one or more embodiments, the polymer includes one or more alpha-branched ketones, one or more isolated ketones, or both.

An in-chain ketone may be an isolated ketone or an alpha-branched ketone. An isolated in-chain ketone is a an in-chain ketone that does not have a branch extending from either of the two alpha carbons of the ketone carbonyl carbon. FIG. 1 shows an example of a isolated in-chain ketone (“linear isolated carbonyl”). An alpha-branched ketone has a branch extending from a carbon in the backbone that is alpha to the carbonyl carbon of the ketone or has a branch extending from a carbon in a branch that is alpha to the carbonyl carbon of the ketone. FIG. 1 shows examples of an alpha-branched ketone (“long alkyl branched carbonyl” and “methyl branched carbonyl”.)

In one or more embodiments, the polymer includes one or more isolated ketones. An isolated ketone may be formed by 2,1-insertion of the alpha-olefin monomer and subsequent chain straightening (See FIG. 1, “linear isolated carbonyl”).

In one or more embodiments, the alpha-branched ketone is an alpha-methyl-branched ketone. In one or more embodiments, the alpha-branched ketone is an alpha-methyl-branched ketone of Formula (I)

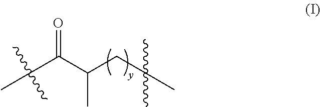

where y is an integer of 1 or greater. In one or more embodiments, y is an integer from 1 to 30 (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30). The alpha-methyl-branched ketone is covalently attached to the polymer at the two points or attachment. For example, the alpha-methyl-branched ketone of Formula (I) may be a portion of the polymer backbone chain. In embodiments where the alpha-methyl-branched ketone is a part of the larger polymer backbone chain, it is understood that y does not necessarily represent the number of carbons between ketones in the polymer backbone chain. In one or more embodiments, y greater than or equal to two fewer than the number of carbons in the linear alpha-olefin used to form the polymer. For example, in embodiments where the alpha-olefin is a C8 alpha-olefin, y may be 6. In one or more embodiments, the alpha-methyl-branched ketone is a part of the backbone.

In one or more embodiments, the alpha-branched ketone is an alpha-alkyl-branched ketone. In one or more embodiments, the alpha branched ketone is an alpha-alkyl-branched ketone of Formula (II)

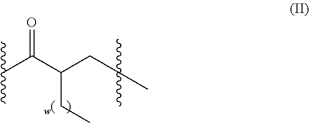

where w is an integer of 1 or greater. In one or more embodiments, w is 1 to 30 (e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30). The alpha-alkyl-branched ketone is covalently attached to the polymer at the two points or attachment. In one or more embodiments, the alpha-alkyl-branched ketone of Formula (I) is a portion of the polymer backbone chain. In one or more embodiments, w is three fewer than the number of carbons in the linear alpha-olefin used to form the polymer. For example, in embodiments where the alpha-olefin is a C8 alpha-olefin, w may be 5. In one or more embodiments, the alpha-methyl-branched ketone is a part of the backbone.

In one or more embodiments, the polymer includes one or more methyl branches, one or more alkyl branches, or both. In one or more embodiments, the polymer includes one or more isolated ketones, one or more alpha-branched ketones, or any combination thereof. In one or more embodiments, the polymer includes one or more isolated ketones, one or more alpha-alkyl ketones, or any combination thereof. In one or more embodiments, the polymer includes one or more alpha-branched ketones, one or more alpha-alkyl ketones, or any combination thereof. In one or more embodiments, the polymer includes one or more isolated ketones, one or more alpha-methyl-branched ketones, one or more alpha-alkyl-branched ketones, or any combination thereof.

The melting temperature (Tm) of the polymer may vary, for example, based on its intended use. For example, a polymer used for a plastic tube may have a higher Tm than a polymer used for plastic wrap. Differential scanning calorimetry may be used, for example, to determine the Tm of a polymer. In one or more embodiments, a polymer of the present disclosure may have a Tm of 10° C. or greater, 15° C. or greater, 20° C. or greater, 25° C. or greater, 30° C. or greater, 35° C. or greater, 40° C. or greater, 45° C. or greater, 50° C. or greater, 55° C. or greater, 60° C. or greater, 65° C. or greater, 70° C. or greater, 75° C. or greater, 80° C. or greater, 85° C. or greater, 90° C. or greater, 95° C. or greater, 100° C. or greater, 105° C. or greater, 110° C. or greater, 115° C. or greater, 120° C. or greater, 125° C. or greater, 130° C. or greater, 140° C. or greater, 150° C. or greater, or 175° C. or greater. In one or more embodiments, a polymer of the present disclosure may have a Tm of 200° C. or less, 175° C. or less, 150° C. or less, 140° C. or less, 135° C. or less, 130° C. or less, 125° C. or less, 120° C. or less, 115° C. or less, 100° C. or less, 95° C. or less, 90° C. or less, 85° C. or less, 80° C. or less, 75° C. or less, 70° C. or less, 65° C. or less, 60° C. or less, 50° C. or less, 45° C. or less, 40° C. or less, 35° C. or less, 30 or less, 25° C. or less, 20° C. or less, or 15° C. or less. In one or more embodiments, the polymer has a Tm of 100° C. to 175° C., such as 110° C. to 160° C., or 110° C. to 130° C. In one or more embodiments, the polymer has a Tm that is comparable to LLPDE. For example, in one or more embodiments, the polymer has a Tm of 100° C. to 160° C., 110° C. to 130° C., or 120° C. to 125° C.

The degree of CO incorporation (the number of in-chain ketones) in the polymer may affect the degradability of the polymer, the Tm of the polymer, or both. Generally, a polymer having a higher degree of CO incorporation will have a higher Tm than the same polymer having the same branching density but less CO incorporation. The degree of CO incorporation in a polymer can be described in several ways including the number of alpha-olefin units per each CO unit in the polymer (olefin/CO ratio); the mole percent (mol-%) CO calculated relative to the alpha-olefin units of the polymer; and the mol-% CO calculated relative to the ethylene equivalent units of the polymer. All CO incorporation metrics can be determined, for example, using magnetic resonance spectroscopy (NMR), such as ¹³C NMR, ¹H NMR, or both.

The olefin to CO ratio quantifies how many alpha-olefin units (incorporated alpha-olefine monomers) are present in the polymer for each in-chain ketone in the polymer. A larger ratio indicates fewer in-chain ketones in the polymer. In one or more embodiments, a polymer of the present disclosure may have an average olefin/CO ratio of 1 or more olefins per CO, 2 or more olefins per CO, 3 or more olefins per CO, 4 or more olefins per CO, 5 or more olefins per CO, 6 or more olefins per CO, 7 or more olefins per CO, 8 or more olefins per CO, 9 or more olefins per CO, 10 or more olefins per CO, 12 or more olefins per CO, 14 or more olefins per CO, 16 or more olefins per CO, 18 or more olefins per CO, 20 or more olefins per CO, 25 or more olefins per CO, 30 or more olefins per CO, 40 or more olefins per CO, 50 or more olefins per CO, 60 or more olefines per CO, 70 or more olefines per CO, 80 or more olefines per CO, 90 or more olefines per CO, 100 or more olefines per CO, 125 or more olefines per CO, 150 or more olefines per CO, or 175 or more olefines per CO. In one or more embodiments, a polymer of the present disclosure may have an average olefin/CO ratio of 200 or fewer olefines per CO, 175 or fewer olefines per CO, 150 or fewer olefines per CO, 125 or fewer olefines per CO, 100 or fewer olefines per CO, 90 or fewer olefines per CO, 80 or fewer olefines per CO, 70 or fewer olefines per CO, 60 or fewer olefines per CO, 50 or fewer olefins per CO, 40 or fewer olefins per CO, 30 or fewer olefins per CO, 25 or fewer olefins per CO, 20 or fewer olefins per CO, 18 or fewer olefins per CO, 16 or fewer olefins per CO, 14 or fewer olefins per CO, 12 or fewer olefins per CO, 10 or fewer olefins per CO, 9 or fewer olefins per CO, 8 or fewer olefins per CO, 7 or fewer olefins per CO, 6 or fewer olefins per CO, 5 or fewer olefins per CO, 4 or fewer olefins per CO, 3 or fewer olefins per CO, or 2 or fewer olefins per CO.

The mol-% CO described relative to the number of alpha-olefins in the polymer is calculated assuming that 100 mol-% is the sum of the mol-% CO and the mol-% alpha-olefin. In one or more embodiments, the mol-% CO in the polymer calculated relative to the alpha-olefin units in the polymer is 0.01 mol-% CO or greater, 0.1 mol-% CO or greater, 0.5 mol-% CO or greater, 0.75 mol-% CO or greater, 1 mol-% CO or greater, 1.25 mol-% CO or greater, 1.5 mol-% CO or greater, 1.75 mol-% CO or greater, 2 mol-% CO or greater, 2.5 mol-% CO or greater, 2.75 mol-% CO or greater, 3 mol-% CO or greater, 3.5 mol-% or greater, 4 mol-% CO or greater, 5 mol-% CO or greater, 6 mol-% CO or greater, 7 mol-% CO or greater, 8 mol-% CO or greater, 9 mol-% CO or greater, 10 mol-% CO or greater, 15 mol-% CO or greater, 20 mol-% CO or greater, 25 mol-% CO or greater, 30 mol-% or greater, or 40 mol-% or greater. In one or more embodiments, the mol-% CO in the polymer calculated relative to alpha-olefin units in the polymer is 50 mol-% or less, 40 mol-% or less, 30 mol-% CO or less, 25 mol-% CO or less, 20 mol-% CO or less, 15 mol-% CO or less, 10 mol-% CO or less, 10 mol-% CO or less, 9 mol-% CO or less, 8 mol-% CO or less, 7 mol-% CO or less, 6 mol-% CO or less 5 mol-% CO or less, 4 mol-% CO or less, 3.5 mol-% CO or less, 3 mol-% CO or less, 2.75 mol-% CO or less, 2.5 mol-% CO or less, 2.25 mol-% CO or less, 2 mol-% CO or less, 1.75 mol-% CO or less, 1.5 mol-% CO or less, 1.25 mol-% CO or less, 1 mol-% CO or less. 0.75 mol-% CO or less, 0.5 mol-% CO or less, 0.25 mol-% CO or less, or 0.1 mol-% CO or less.

The mol-% CO calculated relative to ethylene unit equivalents may allow for comparison of CO amounts in polymers polymerized with different alpha-olefin monomers and/or a poly(ethylene) polymer having alternating and/or non-alternating ketones. The mol-% CO relative to the ethylene unit equivalents is calculated by dividing the mol-% CO calculated relative to the alpha-olefin units by the number of ethylene equivalents of the alpha-olefin monomer. The number of ethylene equivalents per a specific alpha-olefin monomer is half the number of carbons in the alpha-olefin monomer. For example, an alpha-olefin monomer having 6 carbons (hexene) has 3 ethylene equivalents. A polymer polymerized from hexene having a 30 mol-% CO calculated relative to the hexene units in the polymer also has a 10 mol-% CO calculated relative to ethylene unit equivalents. In one or more embodiments, the mol-% CO calculated relative to ethylene unit equivalents in the polymer is 0.01 mol-% CO or greater, 0.1 mol-% CO or greater, 0.5 mol-% CO or greater, 0.75 mol-% CO or greater, 1 mol-% CO or greater, 1.25 mol-% CO or greater, 1.5 mol-% CO or greater, 1.75 mol-% CO or greater, 2 mol-% CO or greater, 2.5 mol-% CO or greater, 2.75 mol-% CO or greater, 3 mol-% CO or greater, 3.5 mol-% or greater, 4 mol-% CO or greater, 5 mol-% CO or greater, 6 mol-% CO or greater, 7 mol-% CO or greater, 8 mol-% CO or greater, 9 mol-% CO or greater, 10 mol-% CO or greater, 15 mol-% CO or greater, or 20 mol-% CO or greater. In one or more embodiments, the mol-% of CO calculated relative to ethylene unit equivalents in the polymer is 25 mol-% CO or less, 20 mol-% CO or less, 15 mol-% CO or less, 10 mol-% CO or less, 9 mol-% CO or less, 8 mol-% CO or less, 7 mol-% CO or less, 6 mol-% CO or less 5 mol-% CO or less, 4 mol-% CO or less, 3.5 mol-% CO or less, 3 mol-% CO or less, 2.75 mol-% CO or less, 2.5 mol-% CO or less, 2.25 mol-% CO or less, 2 mol-% CO or less, 1.75 mol-% CO or less, 1.5 mol-% CO or less, 1.25 mol-% CO or less, 1 mol-% CO or less. 0.75 mol-% CO or less, 0.5 mol-% CO or less, 0.25 mol-% CO or less, or 0.1 mol-% CO or less. In one or more embodiments, the mole-% CO calculated relative to the ethylene unit equivalents in the polymer is 0.01 mol-% to 5 mol-% CO such as 1 mol-% to 4 mol-% CO or 2 mol-% to 3 mol-% CO.

The branching density of a polymer may be described by the average number of branches per every 1000 carbons (B value or B). NMR spectroscopy, for example, may be used to calculate the B value. In general, the greater the B value, the lower the thermal melting temperature of the polymer. In one or more embodiments, the polymer has a B value of 1 or greater, 5 or greater, 10 or greater, 20 or greater, 30 or greater, 40 or greater, 50 or greater, 60 or greater, 70 or greater, 80 or greater, 90 or greater, 100 or greater, 110 or greater, 120 or greater, 130 or greater, 140 or greater, 150 or greater, 160 or greater, 170 or greater, 180 or greater, or 190 or greater. In one or more embodiments, the polymer has a B value of 200 or less, 190 or less, 180 or less, 170 or less, 160 or less, 150 or less, 140 or less, 130 or less, 120 or less, 110 or less, 100 or less, 90 or less, 80 or less, 70 or less, 60 or less, 50 or less, 40 or less, 30 or less, 20 or less, 10 or less, or 5 or less. In one or more embodiments, the polymer has a B value of 1 to 50 such as 5 to 40 or 10 to 30.

The degree of methyl to alkyl branches, such as alpha-methyl-branched ketones to alpha-alkyl-branched ketones, in a polymer may be described as the ratio of methyl branches to alkyl branches. In one or more embodiments, a polymer has a methyl-branch to alkyl-branch ratio of 0.01 methyl branches or greater per alkyl branch, 0.1 methyl branches or greater per alkyl branch, 0.2 methyl branches or greater per alkyl branch, 0.5 methyl branches or greater per alkyl branch, 0.8 methyl branches or greater per alkyl branch, 1 methyl branch or greater per alkyl branch, 1.2 methyl branches or greater per alkyl branch, 1.4 methyl branches or greater per alkyl branch, 1.6 methyl branches or greater per alkyl branch, 1.8 methyl branches or greater per alkyl branch, 2.0 methyl branches or greater per alkyl branch, 2.2 methyl branches or greater per alkyl branch, 2.4 methyl branches or greater per alkyl branch, 2.6 methyl branches or greater per alkyl branch, 2.8 methyl branches or greater per alkyl branch, 3 methyl branches or greater per alkyl branch, 4 methyl branches or greater per alkyl branch, or 5 methyl branches or greater per alkyl branch. In one or more embodiments, a polymer may have a methyl branch to alkyl branch ratio of 10 methyl branches or less per alkyl branch, 5 methyl branches or less per alkyl branch, 4 methyl branches or less per alkyl branch, 3 methyl branches or fewer per alkyl branch, 2.8 methyl branches or fewer per alkyl branch, 2.6 methyl branches or fewer per alkyl branch, 2.4 methyl branches or fewer per alkyl branch, 2.2 methyl branches or fewer per alkyl branch, 2.0 methyl branches or fewer per alkyl branch, 1.8 methyl branches or fewer per alkyl branch, 1.6 methyl branches or fewer per alkyl branch, 1.4 methyl branches or fewer per alkyl branch, 1.2 methyl branches or fewer per alkyl branch, 1.0 methyl branches or fewer per alkyl branch, 0.8 methyl branches or fewer per alkyl branch, 0.5 methyl branches or fewer per alkyl branch, 0.2 methyl branches or fewer per alkyl branch, 0.1 methyl branches or fewer per alkyl branch.

The number-average molecular weight (Mn) of the polymers of the present disclosure may vary. Mn is calculated using the following equation:

$$Mn = \sum {x}_{i} {M}_{i}$$

where Mᵢ is the mean molecular size of range i and xᵢ is the number fraction of the total number of polymer chains that are within Mᵢ range. Mn may be determined using size exclusion chromatography with a multi-angle light scattering detector.

In one or more embodiments, the Mn of the polymer is 5 kilodalton (kDa) or greater, 10 kDa or greater, 20 kDa or greater, 25 kDa or greater, 50 kDa or greater, 75 kDa or greater, 100 kDa or greater, 125 kDa or greater, 150 kDa or greater, 200 kDa or greater, 300 kDa or greater, or 400 kDa or greater. In one or more embodiments, the Mn of the polymer is 500 kDa or less, 400 kDa or less, 300 kDa or less, 200 kDa or less, 150 kDa or less, 125 kDa or less, 100 kDa or less, 75 kDa or less, 50 kDa or less, 25 kDa or less, 20 kDa or less, or 10 kDa or less. In one or more embodiments, the Mn of the polymer is 5 kDa to 100 kDa, 5 kDa to 75 kDa, 5 kDa to 50 kDa, 5 kDa to 40 kDa, 5 kDa to 30 kDa, 5 kDa to 25 kDa, 5 kDa to 20 kDa, or 5 kDa to 10 kDa. In one or more embodiments, the Mn of the polymer is 10 kDa to 200 kDa such as 50 kDa to 150 kDa or 75 kDa to 125 kDa.

The weight-average molecular weight (Mw) of a polymer of the present disclosure may vary. Mw is calculated using the following equation:

$$Mw = \sum {w}_{i} {M}_{i}$$

where Mᵢ is the mean molecular size of range i and wᵢ is the weight fraction of the total number of polymer chains that are within Mᵢ range. Mw may be determined using size exclusion chromatography with a multi-angle light scattering detector (see Example).

In one or more embodiments, the Mw of the polymer is 5 kilodalton (kDa) or greater, 10 kDa or greater, 20 kDa or greater, 25 kDa or greater, 50 kDa or greater, 75 kDa or greater, 100 kDa or greater, 125 kDa or greater, 150 kDa or greater, 200 kDa or greater, 300 kDa or greater, or 400 kDa or greater. In one or more embodiments, the Mn of the polymer is 500 kDa or less, 400 kDa or less, 300 kDa or less, 200 kDa or less, 150 kDa or less, 125 kDa or less, 100 kDa or less, 75 kDa or less, 50 kDa or less, 25 kDa or less, 20 kDa or less, or 10 kDa or less. In one or more embodiments, the Mw of the polymer is 5 kDa to 100 kDa, 5 kDa to 75 kDa, 5 kDa to 50 kDa, 5 kDa to 40 kDa, 5 kDa to 30 kDa, 5 kDa to 25 kDa, 5 kDa to 20 kDa, or 5 kDa to 10 kDa. In one or more embodiments, the Mw of the polymer is 10 kDa to 200 kDa such as 50 kDa to 150 kDa or 75 kDa to 125 kDa.

The dispersity of the molecular weight of the polymer affect the characteristics of the polymer. The molecular weight dispersity may be quantified as the dispersity (Ð_{M}). Ð_{M} is the distribution of individual molecular masses of a polymer. Ð_{M} is calculated as the quotient of the mass average molecular weight (M_{w}) divided by the number-average molecular weight (Mₙ). The M_{w} and Mₙ may be determined using various methods including viscometry, size exclusion chromatography, and mass spectrometry. Generally, a small Ð_{M} is preferred. Although there is no desired lower limit, in practice the Ð_{M} of the polymer may be 1.0 or greater, 1.1 or greater, 1.2 or greater, 1.3 or greater, 1.4 or greater, 1.5 or greater, 1.6 or greater, 1.7 or greater, 1.8 or greater, 1.9 or greater, 2.0 or greater, 2.1 or greater, 2.2 or greater, 2.3 or greater. 2.3 or greater, or 2.4 or greater. In one or more embodiments, the Ð_{M} of the polymer may be 2.5 or less, 2.2 or less, 2.0 or less, 1.8 or less, 1.7 or less, 1.6 or less, 1.5 or less, 1.4 or less, 1.3 or less, 1.2 or less, or 1.1 or less.

In one or more embodiments, the polymer is degradable. A degradable polymer decomposes into two or more compounds having a lower molecule weight (lower Mn and/or Mw) than the molecular weight of the original polymer. Degradation of a degradable polymer may occur in response to a stimulus, for example, ultraviolet light. In one or more embodiments, the polymer is photodegradable. For example, the polymer may degrade upon exposure to ultraviolet light. Without wishing to be bound by theory, it is thought that the in-chain ketones of the polymer may allow the polymer to be photodegradable.

In another aspect, the present disclosure describes a composition that includes a polymer of the present disclosure. The composition may be a lubricant composition. The composition may be a degradable lubricant composition. The compostion may be plastic composition, such as, for example a plastic bag or plastic packaging composition.

In another aspect, the present disclosure describes a method of making the polymer of the present disclosure.

Ethylene polymerization typically makes use of a transition metal catalyst such as an early transition metal catalyst. Late transition metal catalysts are often used for ethylene copolymerize with polar functional monomers. Synthesis methods of producing alternating olefin/CO are known and produce polymers (having alternating in-chain ketones) that have several unique material properties, such as high mechanical strength, high chemical resistance and good barrier properties. In contrast, development of non-alternating ethylene/CO copolymerization is challenging due to the inherent thermodynamic constraint. The favorable CO coordination over ethylene coordination to the catalyst prevents double insertion of ethylene, even though typical bisphosphine palladium (Pd) catalysts for ethylene/CO copolymerization can oligomerize ethylene in the absence of CO. Current approaches for the synthesis of polyethylene with in-chain ketones use harsh conditions, customized high-pressure ethylene/CO gas mixture, or radical polymerization.

In contrast to current approaches to synthesize polyethylene having non-alternating in-chain ketones, the present disclosure describes a method that includes the use of an alpha-olefin monomer, a liquid-gas reaction, and a late-transition metal catalyst to produce the branched poly(alpha-olefin) polymers having in-chain ketones, such as the polymers described herein.

The method of the present disclosure includes exposing a reaction mixture to carbon monoxide for a reaction time. The carbon monoxide may be gaseous carbon monoxide. The reaction mixture may be a liquid-containing reaction mixture. The reaction mixture may be a solution reaction mixture. The reaction mixture includes an alpha-olefin monomer and a catalyst.

The alpha-olefin monomer may be any alpha-olefin monomer as described herein. The concentration of the alpha-olefin in the reaction mixture may vary. For example, the concentration of the alpha-olefin in the reaction mixture may be 1 mmol to 5 M, such as 1 mmol to 1 mmol, 100 mmol to 5 M, or 1 M to 5 M.

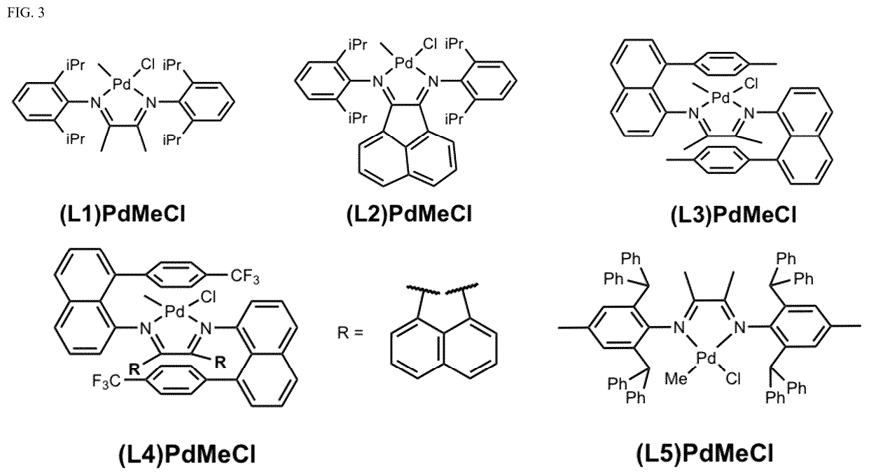

The catalyst may be a late-transition metal (e.g., nickel and palladium) catalyst. In one or more embodiments the catalyst includes palladium. In one or more embodiments, the catalyst is a diimine late transition metal catalyst such as an alpha-diimine late transition metal catalyst. In one or more embodiments, the catalyst includes the diimine ligands of L1, L2, L3, L4, or L5 (see FIG. 3 for the structure of L1, L2, L3, L4, L5). In one or more embodiments, the catalyst is (L1)PdMeCl, (L2)PdMeCl, (L3)PdMeCl, (L4)PdMeCl, or (L15)PdMeCl. The concentration of the catalyst in the reaction mixture may vary. For example, the concentration of the catalyst in the reaction mixture may be 0.001 mmol to 5 mmol such as 0.01 mmol to 0.5 mmol.

The reaction mixture may include a solvent. The solvent may be a hydrocarbon solvent, a polar aprotic solvent, or a combination thereof. Example solvents include dichloromethane, toluene, chlorobenzene, and any combination thereof.

The reaction mixture may include one or more additives. An example of an additive is a weakly coordinating anion. Examples of weakly coordinating anions include tetraarylborates such as, for example, sodium tetrakis[(3,5-trifluoromethyl)phenyl]borate (NaBArF²⁴ or NaBArF). The amount of any one additive in the reaction mixture may vary. For example, the amount of an additive in the reaction mixture may be 0.001 mmol to 0.5 mmol such as 0.01 mmol to 0.05 mmol.

Exposure of the reaction mixture to carbon monoxide may be accomplished by a variety of techniques. For example, the reaction mixture may be in a sealed vessel and a balloon containing carbon monoxide gas may be fluidically coupled to the sealed vessel. In one or more embodiments, the CO is provided at a low pressure. For example, CO is provided at a pressure of 10 atm (1013 kPa) or less, 5 atm (506 kPa) or less, 2 atm (202 kPa) or less, or 1 atm (101 kPa) or less.

The reaction time may vary. For example, the reaction time may be from 0.1 hours to 48 hours such as, for example, 1 hour to 48 hours, 10 hours to 30 hours, or 10 hours to 20 hours.

The reaction may be carried out at various temperatures. As such, in one or more embodiments, the method further includes exposing the reaction mixture to a reaction temperature. In one or more embodiments, the reaction temperature may be 20° C. or greater, 30° C. or greater, 40° C. or greater, 50° C. or greater, 60° C. or greater, 70° C. or greater, 80° C. or greater, or 90° C. or greater. In one or more embodiments, the reaction temperature may be 100° C. or less, 90° C. or less, 80° C. or less, 70° C. or less, 60° C. or less, 50° C. or less, 40° C. or less or 30° C. or less.

Various alpha-olefins were copolymerized with CO using various alpha-diimine Pd catalysts to produce poly(alpha-olefin polymers) having in-chain ketones. The alpha-diimine Pd catalysts had high chain-walking reactivities allowing CO insertion at low pressures with a simple experimental setup. In contrast to the conventional high-pressure ethylene/CO gas mixture experiment design, different chain lengths of alpha-olefins were used to achieve structural control of resulting CO/olefin copolymers. Additionally, this technique allows more methylene spacing between in-chain ketones compared to current non-alternating ethylene/CO copolymer synthesis typically catalyzed by a phosphine sulfonate Pd catalyst. The reversibility of CO insertion under low-pressure conditions has a low impact on the chain-walking capabilities of some of the alpha-diimine Pd catalysts. As such, non-alternating CO/alpha-olefin insertion behavior was observed where extension of methylene carbons between carbonyl groups is a result of chain straightening. Supported by experiments employing ¹³CO labeling, linear isolated carbonyls were clearly observed in the poly(alpha-olefin) polymers. Furthermore, the formation of methyl-branched and alkyl-branched carbonyl groups were characterized according to their olefin insertion pathways. The branched structure of the polymers is a result of insertion regioselectivity (1,2-insertion or 2,1-insertion) and chain-walking after the insertion of alpha-olefin monomer. Catalyst controlled branch density of polyethylene synthesized from an alpha-olefin may allow for the ability to produce poly(alpha-olefin) polymers with in-chain ketones having various thermal properties. In addition to the catalyst dependent branch density, longer chain alpha-olefins such as 1-octene and 1-decene showed higher polymer crystallinity compared to polymerization with 1-hexene. The polymer microstructures were varied according to different reaction conditions, alpha-olefin monomers, and catalysts.

The (alpha-diimine)PdMeCl catalysts ((L1)PdMeCl, (L2)PdMeCl, (L3)PdMeCl, (L4)PdMeCl, and (L5)PdMeCl; See FIG. 3 for the structures) tested were synthesized according to an established method (J. Am. Chem. Soc. 2014, 136, 20, 7213-7216, doi.org/10.1021/ja502130w; ACS Catal. 2015, 5, 1, 456-464, doi.org/10.1021/cs5016029; Angewandte Chemie International Edition 2015, 54, 34, 9948-9953, doi.org/10.1002/anie.201503708; J. Am. Chem. Soc. 1995, 117, 23, 6414-6415, doi.org/10.1021/ja00128a054). L1 and L2 were first reported for highly branched polyethylene synthesis. L3 includes a sandwich structure to block the coordination at the axial position of the metal. Such sandwich structure limits chain transfer and enables living polymerization of ethylene. L4 as a Ni complex was previously reported as a 2,1-insertion selective (1,ω-enchainment) catalyst to facilitate chain straightening for linear polyethylene synthesis. L4 as a Pd complex has not been reported of olefin polymerization.

Initial attempts of the copolymerization of an alpha-olefin with CO failed. In a first attempt, 2 molar (M) of 1-hexene in dichloromethane (DCM) with 0.125 mmol-% of (L1)PdMeCl under 100 psig (689 kPa) of CO resulted in no product. Additionally, substantial catalyst decomposition was observed as the reaction solution turned black in a short period of time. In a second attempt, a Fisher-Porter tube was loaded with hexene, (L1)PdMeCl and NaBArF, under 15 psig (352 kPa) of CO. However, this condition also led to complete decomposition of the catalyst.

Copolymerization of an alpha-olefin with CO was successful when CO was provided at a low pressure. Specifically, a balloon filled with CO was used to provide CO to the reaction mixture to see if the slow introduction of CO would allow the polymerization of olefin and decrease catalyst decomposition. The reaction mixture included 1 mmol-% (L1)PdMeCl, 1.2 mmol % NaBArF, 2 M 1-hexene, and DCM. Compared to general late-transition metal catalyzed alpha-olefin polymerization, a 5 to 10 times higher loading of catalyst (1 mmol-%) was used due to the previously observed lack of stability of (L1)PdMeCl under CO. The resultant polymer product collected after catalyst removal had an Mn of 15.1 kg/mol. The ¹H NMR spectra revealed a slightly broad signal at 2.25-3.2 ppm along with a triplet at 2.30 ppm suggesting in-chain ketone product formation. ¹³C NMR spectroscopy was conducted to further characterize the polymer. Although the ¹³C NMR spectrum did not show a clear signal in the carbonyl region (210-215 ppm), a notable signal at 42 ppm suggests a methylene carbon alpha to a carbonyl carbon thereby suggesting the presence of isolated ketones.

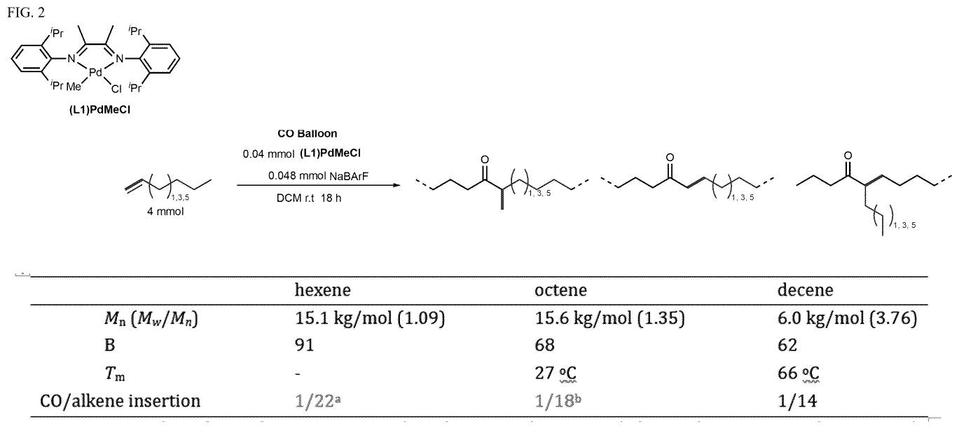

Using the conditions in FIG. 2 (CO balloon, 0.04 mmol (L1)PdMeCl), 0.048 mmol NaBArF, DCM, room temperature, 18 hours and 2M of alpha-olefins) CO was separately copolymerized with hexene, octene, and decene. FIG. 2 shows several characteristics of the resultant polymers. This data indicates that branching density may be influenced by the identity of the alpha-olefin monomer. Additionally, CO incorporation into the polymer was low. This low incorporation may allow for the polymer to have similar properties to poly(ethylene).

L1 can catalyze hyper-branched polyethylene via chain-walking. Fast chain-walking along the alpha-olefin backbone can produce a high branching density (B value). It was hypothesized that copolymerization of CO with longer chain alpha-olefin monomers may be able to achieve a higher crystallinity at a similar conversion as compared to ethylene polymerization with L1. Specifically, the additional methylenes present in longer chain alpha-olefin monomers may lower the branching density for a given number of carbons in the polymer. This trend is apparent in FIG. 2. For example, the branching density decreases for polymers polymerized with long-chain alpha-olefin monomers. As the branching density decreases, the Tm increases.

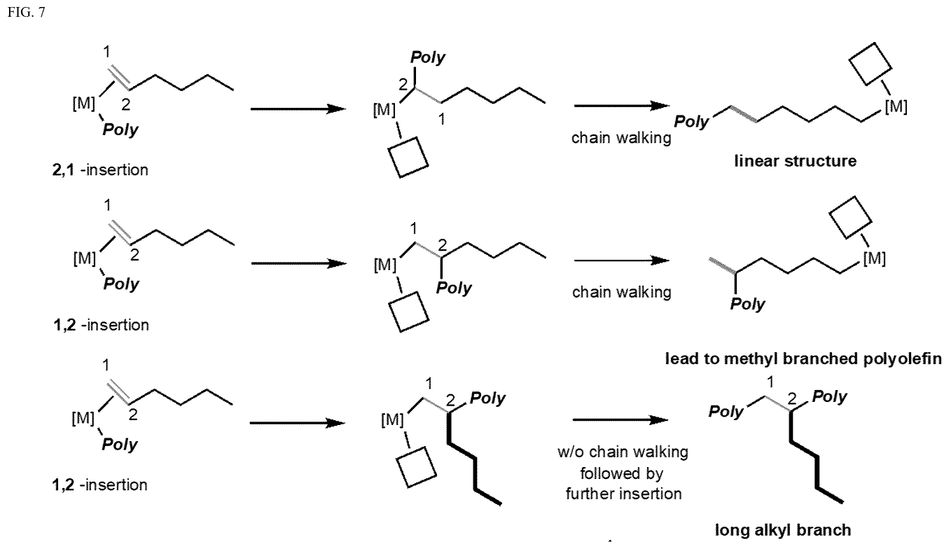

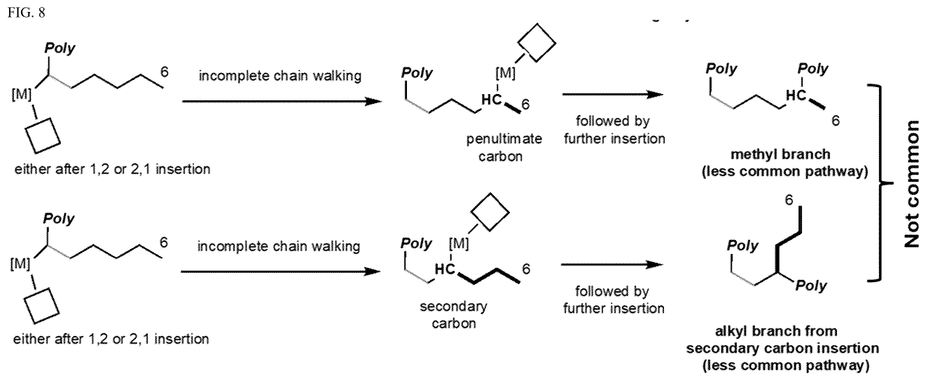

To elucidate microstructure detail, analysis of branch structure of various polymers was interpreted from ¹H and ¹³C NMR spectroscopy. Methyl and alkyl branches are generally associated with 1,2-insertion of an alpha-olefin and linear structures are generally associated with 2,1-insertion followed by chain straightening (FIG. 1 and FIG. 7). However, it may be misleading to count only methyl and alkyl branches as a measure of regioselectivity because methyl and alkyl branches can originate from pathways other than 1,2-insertion. For example, methyl and alkyl branches can originate from any of the mechanisms shown in FIG. 7 or FIG. 8. For example, a secondary carbon or penultimate carbon insertion of the alpha-olefin may complicate the regioselectivity determination by adding additional methyl branches and/or alkyl branches. Previous studies have indicated that long chain alkyl branches can largely attributed to the simple insertion of olefin (Macromolecules 2017, 50, 18, 7010-7027, doi.org/10.1021/acs.macromol.7b01150). In the case of Table 2, entry 2, the methyl-branched to alkyl-branched ratio, suggest 1,2-insertion or penultimate secondary carbon insertion is almost twice as much as simple olefin insertion without chain-walking.

In the ¹³C NMR spectrum, the signal at 42.8 ppm of octene/CO copolymer is the methylene carbon adjacent to the isolated carbonyl. In the ¹H NMR spectrum, the methyl signals are either the methyl branch or the methyl groups of long chain branches. Although the carbonyl signal was not observable in regular ¹³C NMR spectroscopy, ¹H-¹³C HMBC spectroscopy suggested the correlation between the triplet 2.30 ppm in the 1H spectrum and the 211.5 ppm signal in the ¹³C spectrum. The chemical shift of carbonyl in ¹³C spectrum is close to the long distanced carbonyl (carbonyls that are separated by 6 or more carbons) chemical shift previously reported. Further HMBC spectrum analysis indicated that the signals at 23.8 ppm and 29.3 ppm are correlated to the beta and gamma methylenes of an isolated carbonyl, respectively. In addition, attenuated total reflectance infrared spectroscopy (ATR IR) showed a carbonyl stretching signal at 1708 cm⁻¹ suggesting a distanced carbonyl (non-alternating ketones) signal compared to signal from alternating ketones (a propene/CO alternating polyketone carbonyl stretching 1699 cm⁻¹).

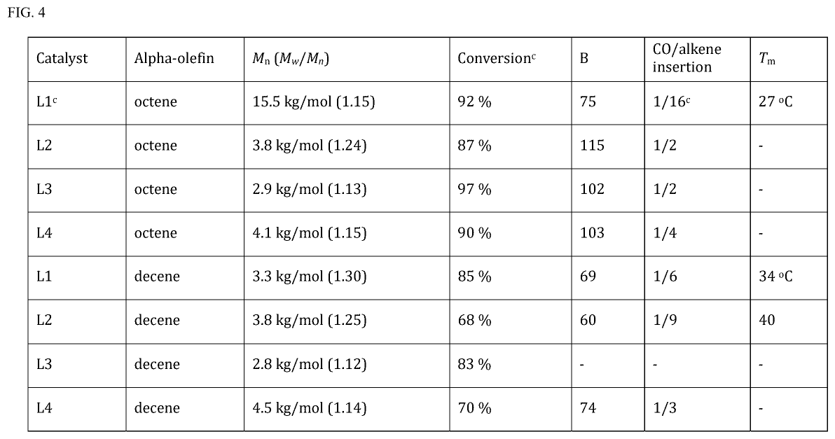

Various catalysts were screened for their ability to affect polymer production and polymer characteristics. In this experiment, CO was copolymerized with either octene or decene and (L1)PdMeCl, (L2)PdMeCl, (L3)PdMeCl, or (L4)PdMeCl (FIG. 3). All polymerizations were run with 1 mmol-% (L)PdMeCl, 1.2 mmol % NaBArF in DCM with 2 M octene or decene under room temperature over 18 h. FIG. 4 shows several characteristics of the resultant polymers. For octene, (L1)PdMeCl produced the polymer with the highest Mn and the lowest CO/olefin insertion ratio. For decene, (L2)PdMeCl produced the polymer with the lowest CO/olefin ratio and (L4)PdMeCl produced the polymer with the highest Mn.

The insertion ratio of olefin to CO can be impacted by inconsistent mass transfer between the liquid-gas interface. Thus, a consistent high stirring rate making use of a large stir bar was used for turbulent movement. Surprisingly, among the different catalysts ((L1-L4)PdMeCl), only (L1)PdMeCl catalyzed octene/CO copolymerization resulting in a relatively high Mn and low CO/alpha-olefin ratio (FIG. 4). ¹H NMR indicated successful CO/octene non-alternating polymerization. For example, comparison of the methylene proton alpha to the ketone carbonyl was compared with the overall proton signal including methyl, methylene, and methine indicated a non-alternating ketone microstructure.

Although a branched poly(octene) polymer having non-alternating in-chain ketones was successfully synthesized, it is thought that the microstructure (e.g., branching density and CO/olefin insertion ratio) may be further controlled. For example, it is thought that the reaction solvent may affect chain-straightening. However, switching the solvent from DCM to toluene for the copolymerization of octene and CO at room temperature with (L1)PdMeCl resulted in significantly lower octene conversion (40%, not including conversion into isomerization product).

In an effort to achieve a low branching density, octene was copolymerized with CO (provided in a CO balloon) using the (L5)PdMeCl catalyst. (L5)PdMeCl has previously been reported for synthesizing low branching density polyethylene. Although the catalyst produced a polymer having a relatively high Tm material (79° C.) and a low branching density (B value of 34), the incorporation of CO was not clearly distinguishable in the ¹H NMR spectroscopy analysis. ATR IR spectrum revealed two carbonyl stretching signals at 1733 cm⁻¹ and 1692 cm⁻¹. The 1733 cm⁻¹ signal deviates from a typical isolated carbonyl stretching by 20-30 cm⁻¹. The low CO component in the polymer may suggest that the catalyst (L5)PdMeCl may have a higher energy barrier for CO insertion. The higher energy barrier may be a result from the electron withdrawing property of the catalyst instead of the steric factor.

Given the observable catalyst decomposition after 18 hours of reaction, 1 mmol-% of catalyst was initially used for all polymerization trials. To see if lower loading of the catalyst is still able to keep high conversion at a reaction time of 18 hours, 0.5 mmol-% L1-L4 catalysts was tested for CO/octene polymerization (results are shown in FIG. 4). Surprisingly, all catalysts were capable of consuming over 90% of 1-octene. Among the 4 different catalysts, the alpha methylene to the carbonyl show different extent of peak broadening in the ¹H NMR spectra of the products. Only the polymer polymerized using the (L1)PdMeCl catalyst showed better resolution of triplet signal at 2.30 ppm, indicative of an isolated carbonyl. However, the Mn of each polymer polymerized using (L1)PdMeCl remained low. Thus, in contrast to living polymerization, this data implies that the initiation event is not the primary factor that influences Mn.

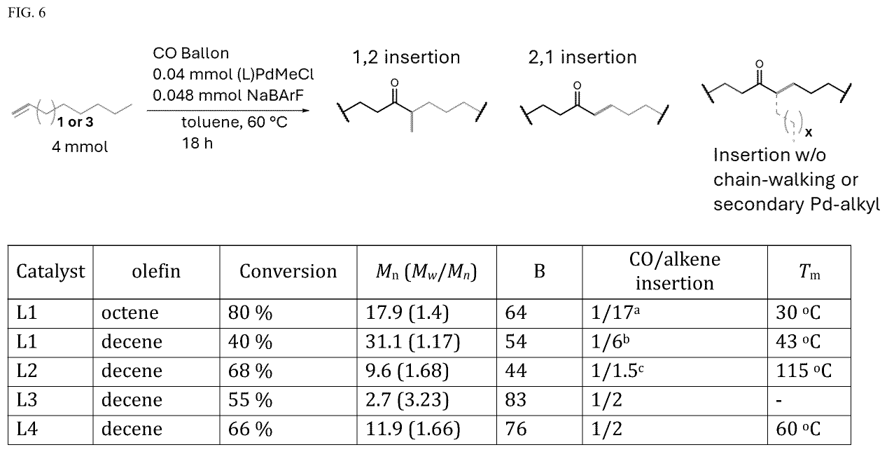

Next, the octene and CO were copolymerized using (L1)PdMeCl at a reaction temperature of 60° C. using the conditions shown in FIG. 6. Regarding octene, the elevated temperature approach lowered the branching density to 64 (as opposed to 68 in FIG. 2, 69 in FIGS. 3 and 75 in FIG. 4) and reflects on the increase in Tm from 27° C. (FIG. 2, FIG. 3, and FIG. 4) to 30° C. Even though the conversion of octene is only 80% using the elevated temperature (as opposed to 92% in FIGS. 3 and 4), the Mn value is roughly the same as the reactions run at room temperature.

To see if further thermal properties can be changed by monomer selection, decene (2M)/CO copolymerization in toluene at 60° C. using various catalysts ((L1-L4)PdMeCl) were tested (FIG. 6). Surprisingly, the polymerization catalyzed by (L2)PdMeCl exhibits a clear triplet ¹H NMR signal at 2.3-2.4 ppm, indicative of a linear isolated carbonyl. Notably, there is much less signal broadening at the 2.4-3.2 ppm region, suggesting less undesirable short distanced ketones (alternating ketones). However, the 1:1.5 CO/olefin insertion ratio may imply some degree of alternating olefin/CO polymerization. Nonetheless, the clear triplet at 2.3 ppm in the ¹H NMR spectrum and 211 ppm in the ¹³C NMR spectrum indicate that chain-walking remains effective and led to more distance between the carbonyls instead of forming alternating decene/CO 1,4-polyketone with 8 carbon alkyl side chain at each repeating unit. In addition, ¹³C signals at 46 ppm and 215 ppm indicate substantial number of methyl-branched ketones. Notably, in assigned ¹H-¹³C HMBC and HSQC spectra, ethyl-branched ketones were observed, suggesting secondary Pd-alkyl insertion is possible.

The copolymerization of decene with CO using the (L2)PdMeCl catalyst resulted in a poly(decene) polymer having in-chain non-alternating ketones with a high Tm of 115° C. (FIG. 6, entry 3). In theory, if the alkyl branch is the major product due to the decene/CO alternating ketone structure, the predominant alkyl branch should cause low crystallinity (low Tm). Moreover, the long chain alpha-olefin/CO copolymer are challenging to synthesize and often have low Mn due to the alkene isomerization (Macromolecules 1992, 25, 11, 2999-3001, doi.org/10.1021/ma00037a035). For example, a relatively regular high Mn propylene/CO alternating copolymer had a Tm up to only 100° C. This suggests that the high CO incorporation relative to olefin under low CO pressure in the conditions tested here does not significantly influence the chain-straightening capability of the catalyst. It is thought that the reversibility of CO insertion under low pressure enables the possibility of having chain-straightening. Additionally, a secondary Pd-alkyl is not as favorable compared to a primary Pd-alkyl for insertion, which leads to more complete chain-walking. In this case, the presence of CO would not significantly disrupt the chain-walking process catalyzed by (L2)PdMeCl. Furthermore, a more frequent insertion of CO enables a relatively regular distanced carbonyl groups, which enhances the dipole-dipole interaction and results in high Tm. This result is one piece of evidence supporting that rapid chain-walking can compete with CO insertion for extending methylene carbons between two carbonyls. Intuitively, 1:1.5 CO to 1-decene insertion ratio appears to be high in CO mol-% insertion. However, when the number of carbons in the polymer is considered, it is equal to a 11 mol-% CO compared to condition under ethylene/CO copolymerization.

When catalyst (L1)PdMeCl is employed for the same decene/CO copolymerization, the Tm does not change as much as the case of (L2)PdMeCl, but the Mn is significantly higher at 31.1 kg/mol with molar mass distribution of 1.17 (FIG. 6). With an insertion ratio of 1/6, it is equal to 3.2 mol-% of CO compared to ethylene insertion. Running polymerization in toluene at 60° C. also improve the polymer Mn and Tm catalyzed by (L4)PdMeCl (FIG. 6). In contrast to the decene/CO copolymerization using (L1)PdMeCl and (L2)PdMeCl, the polymer product of polymerization at 60° C. with (L4)PdMeCl exhibited a more pronounced alternating ketone component in ¹H NMR at around 2.8 ppm. In the case of (L3)PdMeCl, the product oligomer is a low Mn amorphous material (FIG. 6).

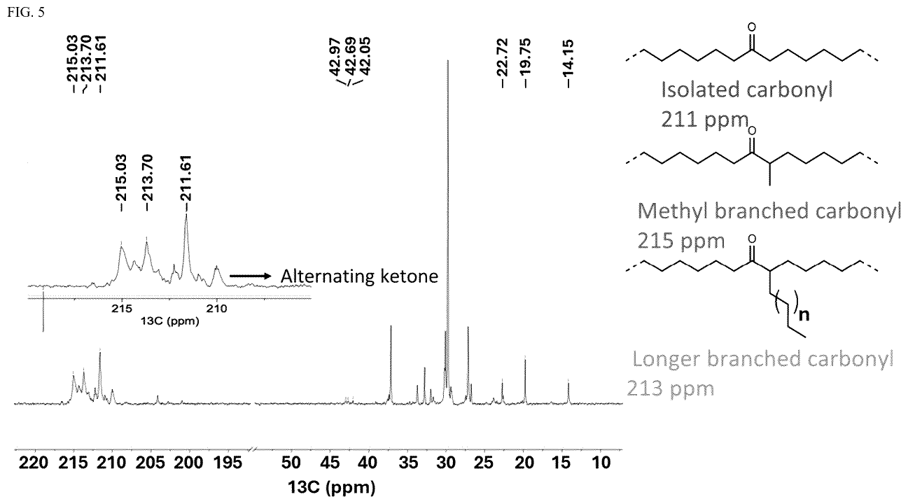

To gain more insight into the microstructure of carbonyl environment, a ¹³CO labelled experiment was conducted on the polymer produced by the copolymerization of octene/¹³CO catalyzed by (L1)PdMeCl in DCM at room temperature (FIG. 5). The carbonyl region suggests the presence of minor alternating octene/CO polyketone at 210 ppm. Again, the signal at 211 ppm verifies the existence of linear isolated carbonyl, while signals at 213 ppm and 215 ppm represent carbonyls next to a long chain alkyl branch and a methyl branch, respectively. Though it is possible to have a carbonyl that is adjacent to 2 methyl branches, a result from penultimate secondary Pd-alkyl insertion followed by 1,2-insertion of octene, it was not observed at a relatively down field region in the ¹³C NMR. This suggests again the Pd-alkyl secondary insertion is not prevalent. In addition, the most prominent methyl groups at the alkyl region are the long chain alkyl branch and methyl branch, indicating other types of branches adjacent to carbonyl is unlikely under this condition.

An additional ¹³CO labelled experiment was performed by decene/¹³CO copolymerization catalyzed by (L2)PdMeCl in toluene at 60° C. The ¹³CO carbonyl signal indicated a majority of the carbonyls were linear isolated carbonyls and methyl-branched carbonyls, with a lower amount of long alkyl-branched carbonyls. With the ¹³CO labelled evidence, high temperature in toluene suggested a faster chain-walking process before CO insertion event due to very little presence of alternating 1,4-ketone carbonyl. Though the synthesized polymer is not able to retain polyethylene thermal properties, the chain-walking strategy allow relative precise control of methylene spacing in between carbonyls and ultimately resulted in high Tm polymer with carbonyl dipole-dipole interaction.

Below there is provided a non-exhaustive listing of non-limiting exemplary embodiment. Any one or more of the features of these embodiments may be combined with any one or more features of another example, embodiment, or aspect described herein.

Exemplary Embodiments (abbreviated in the following list as “E #”)
E1. A polymer polymerized from an alpha-olefin monomer and a carbon monoxide monomer, the polymer comprising:
   a carbon-based backbone formed from carbons of the alpha-olefin monomer and carbon of the carbon monoxide monomer; and
   in-backbone ketones formed from the carbon monoxide monomers, the in-backbone ketones comprising isolated ketones, alpha-branched ketones, or both.
E2. The polymer of Embodiment 1, wherein at least a portion of the in-backbone ketones are non-alternating ketones.
E3. A polymer polymerized from an alpha-olefin monomer and a carbon monoxide monomer, the polymer comprising:
   a carbon-based backbone formed from carbons of the alpha-olefin monomer and carbon of the carbon monoxide monomer; and
   in-chain ketones formed from the carbon monoxide monomers, the in-chain ketones comprising isolated ketones, alpha-branched ketones, or both; wherein at least a portion of the in-chain ketones are in-backbone ketones.
E4. The polymer of Embodiment 3, wherein at least a portion of the in-backbone ketones are non-alternating ketones.
E5. A polymer polymerized from an alpha-olefin monomer and a carbon monoxide monomer, the polymer comprising:
   a carbon-based backbone formed from carbons of the alpha-olefin monomer and carbon of the carbon monoxide monomer; and
   in-chain ketones formed from the carbon monoxide monomers, the in-chain ketones comprising isolated ketones, alpha-branched ketones, or both,
   wherein at least a portion of the in-chain ketones are in-backbone ketones, and
   wherein the polymer comprises 50% or less in-chain alternating ketones based on the total number of in-chain ketones.
E6. The polymer of Embodiment 5, wherein at least a portion of the in-backbone ketones are non-alternating ketones.
E7. A polymer polymerized from an alpha-olefin monomer and a carbon monoxide monomer, the polymer comprising:
   a carbon-based backbone formed from carbons of the alpha-olefin monomer and carbon of the carbon monoxide monomer; and
   in-backbone ketones formed from the carbon monoxide monomers, the in-backbone ketones comprising isolated ketones, alpha-branched ketones, or both, and
   wherein at least a portion of the in-backbone ketones being non-alternating in-backbone ketones.
E8. The polymer of any one of Embodiments 1 to 7, wherein the alpha-branched ketones comprise alpha-methyl-branched ketones, alpha-alkyl-branched ketones, or both.
E9. The polymer of Embodiment 8, wherein the alpha-alkyl-branched ketones comprise a C2 to C24 alkyl branch.
E10. The polymer of any one of Embodiments 1 to 9, wherein the alpha-olefin monomer comprises linear alpha-olefin monomer.
E11. The polymer of Embodiment 10, wherein the linear alpha-olefin monomer comprises a C3 to C30 linear alpha-olefin monomer.
E12. The polymer of any one of Embodiments 1 to 11, wherein the alpha-olefin monomer comprises hexene, octene, or decene.
E13. The polymer of any one of Embodiments 1 to 12, wherein the polymer is degradable.
E14. The polymer of any one of Embodiments 1 to 13, wherein the polymer is photodegradable.
E15. The polymer of any one of Embodiments 1 to 14, where the polymer has a thermal melting temperature of 50° C. to 150° C.
E16. The polymer of any one of Embodiments 1 to 15, wherein the polymer has a thermal melting temperature of 100° C. to 130° C.
E17. The polymer of any one of Embodiments 1 to 16, wherein the polymer has a CO to alpha-olefin ratio of 1 alpha-olefin per CO to 150 alpha-olefins per CO.
E18. The polymer of any one of Embodiments 1 to 17, wherein the polymer has a CO to alpha-olefin ratio of 1 alpha-olefin per CO to 75 alpha-olefins per CO.
E19. The polymer of any one of Embodiments 1 to 18, wherein the polymer has a mol-% CO calculated relative to alpha-olefin units of 0.01 mol-% to 30 mol-%, wherein 100 mol-% is the sum of the mol-% CO and the mol-% alpha-olefin.
E20. The polymer of any one of Embodiments 1 to 19, wherein the polymer has a mol-% CO calculated relative to alpha-olefin units of 0.01 mol-% to 15 mol-%, wherein 100 mol-% is the sum of the mol-% CO and the mol-% alpha-olefin.
E21. The polymer of any one of Embodiments 1 to 20, wherein the polymer has a mol-% CO calculated relative to ethylene unit equivalents of 0.01 mol-% to 15 mol-%.
E22. The polymer of any one of Embodiments 1 to 21, wherein the polymer has a mol-% CO calculated relative to ethylene unit equivalents of 1 mol-% to 5 mol-%.
E23. The polymer of any one of Embodiments 1 to 22, wherein the polymer has a branching density of 1 branch per 1000 carbons to 60 branches per 1000 carbons.
E24. The polymer of any one of Embodiments 1 to 23, wherein the polymer has a branching density of 10 branches per 1000 carbons to 30 branches per 1000 carbons.
E25. The polymer of any one of Embodiments 1 to 24, wherein the polymer has an alpha-methyl-branched ketone to alpha-alkyl-branched ketone ratio of 0.01 alpha-methyl-branched ketones per every alpha-alkyl-branched ketone to 10 alpha-methyl-branched ketones per every alpha-alkyl-branched ketone.
E26. A composition comprising the polymer of any one of Embodiments 1 to 25.
E27. A method of making the polymer of any one of Embodiments 1 to 26.
E28. A method of making a polymer, the method comprising:
   exposing a liquid containing reaction mixture to gaseous carbon monoxide for a reaction time at a reaction temperature, the reaction mixture comprising an alpha-olefin monomer, a catalyst, and a solvent.
E29. The method of Embodiment 28, wherein the alpha-olefine monomer comprises a linear alpha-olefin monomer.
E30. The method of Embodiment 29, wherein the linear alpha-olefin monomer comprises a C3 to C30 linear alpha-olefin monomer.
E31. The method of any one of Embodiments 28 to 30, wherein the alpha-olefin monomer comprises hexene, octene, or decene.
E32. The method of any one of Embodiments 28 to 31, wherein liquid containing reaction mixture is exposed to gaseous carbon monoxide at a pressure of 10 atm (1013 kPa) or less, 5 atm (506 kPa) or less, 2 atm (202 kPa) or less, or 1 atm (101 kPa) or less.
E33. The method of any one of Embodiments 28 to 32, wherein the catalyst is a diimine late transition metal catalyst.
E34. The method of Embodiments 33, wherein the diimine comprises L1, L2, L3, L4, or L5.
E35. The method of any one of Embodiments 28 to 33, wherein the catalyst comprises (L1)PdMeCl, (L2)PdMeCl, (L3)PdMeCl, (L4)PdMeCl, or (L15)PdMeCl.
E36. The method of any one of Embodiments 28 to 35, wherein the reaction mixture comprises 0.001 mmol to 5 mmol of the catalyst.
E37. The method of any one of Embodiments 28 to 35, wherein the reaction mixture comprises a solvent.
E38. The method of Embodiment 37, wherein the solvent comprises dichloromethane, toluene, chlorobenzene, or any combination thereof.
E39. The method of any one of Embodiments 28 to 37, wherein the reaction mixture comprises an additive.
E40. The method of Embodiment 39, wherein the additive comprises a tetraarylborate.
E41. The method of any one of Embodiments 28 to 40, wherein the reaction temperature is 20° C. or greater.

In the preceding description and following claims, the term “and/or” means one or all of the listed elements or a combination of any two or more of the listed elements; the terms “comprises,” “comprising,” and variations thereof are to be construed as open ended—i.e., additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

As used herein, “have,” “has,” “having,” “include,” “includes,” “including,” “comprise,” “comprises,” “comprising” or the like are used in their open-ended inclusive sense, and generally mean “include, but not limited to,” “includes, but not limited to,” or “including, but not limited to.” Further, wherever embodiments are described herein with the language “have,” “has,” “having,” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

In the preceding description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In several places throughout the above description, guidance is provided through lists of examples, which examples can be used in various combinations. In each instance, the recited list serves only as a representative group and should not be interpreted as an exclusive list.

For any method disclosed herein that includes discrete steps, the steps may be performed in any feasible order. And, as appropriate, any combination of two or more steps may be performed simultaneously.

As used herein, the terms “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the invention.

As used herein, the symbol

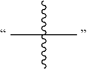

(hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example,

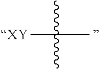

indicates that the chemical entity “XY” is bonded to another chemical entity via the point of attachment bond.

### Examples

The present invention is illustrated by the following example. It is to be understood that the particular example, materials, amounts, and procedures are to be interpreted broadly in accordance with the scope and spirit of the invention as set forth herein.

### Polymerization

All polymerizations were carried out in a 20 mL scintillation vial. All (L)PdMeCl complexes and NaBArF were prepared as a 2 mL dichloromethane or toluene solution with 0.04 mmol of (L)PdMeCl and 0.048 mmol of NaBArF for each reaction in a glove box. The polymerization was subjected to 4 mmol of the alpha-olefin and stirred for 30 seconds before the introduction of CO from a CO balloon. After 18 h, 0.25 mmol of dimethyl terephthalate was added to the reaction solution for conversion determination. For reaction solutions that able to be precipitated in methanol, the reaction solution was concentrated and stirred in methanol for at least 2 hours. Polymer was collected from the precipitate and followed by purification through SiliaMetS Thiol (SH) Metal Scavenger before measuring the size using size exclusion chromatography.

The complete disclosure of all patents, patent applications, and publications, and electronically available material cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A polymer polymerized from alpha-olefin monomers and carbon monoxide monomers, the polymer comprising:
a carbon-based backbone formed from at least a portion of the carbons of the alpha-olefin monomer and at least a portion of the carbons of the carbon monoxide monomer; and
in-backbone ketones formed from the carbon monoxide monomers, the in-backbone ketones comprising isolated ketones, alpha-branched ketones, or both.

2. The polymer of claim 1, wherein the alpha-branched ketones comprise alpha-methyl-branched ketones, alpha-alkyl-branched ketones, or both.

3. The polymer of claim 1, wherein the alpha-olefin monomers comprises linear alpha-olefin monomers.

4. The polymer of claim 3, wherein the linear alpha-olefin monomer comprises a C3 to C30 linear alpha-olefin monomer.

5. The polymer of claim 1, wherein the alpha-olefin monomer comprises hexene, octene, or decene.

6. The polymer of claim 1, wherein the polymer is degradable.

7. The polymer of claim 1, where the polymer has a thermal melting temperature of 50° C. to 150° C.

8. The polymer of claim 1, wherein the polymer has a CO to alpha-olefin ratio of 1 alpha-olefin per CO to 150 alpha-olefins per CO.

9. The polymer of claim 1, wherein the polymer has a mol-% CO calculated relative to alpha-olefin units of 0.01 mol-% to 30 mol-%, wherein 100 mol-% is the sum of the mol-% CO and the mol-% alpha-olefin.

10. The polymer of claim 1, wherein the polymer has a mol-% CO calculated relative to alpha-olefin units of 0.01 mol-% to 15 mol-%, wherein 100 mol-% is the sum of the mol-% CO and the mol-% alpha-olefin.

11. The polymer of claim 1, wherein the polymer has a mol-% CO calculated relative to ethylene unit equivalents of 0.01 mol-% to 15 mol-%.

12. The polymer of claim 1, wherein the polymer has a branching density of 1 branch per 1000 carbons to 60 branches per 1000 carbons.

13. The polymer of claim 1, wherein the polymer has an alpha-methyl-branched ketone to alpha-alkyl-branched ketone ratio of 0.01 alpha-methyl-branched ketones per every alpha-alkyl-branched ketone to 10 alpha-methyl-branched ketones per every alpha-alkyl-branched ketone.

14. A composition comprising the polymer of claim 1.

15. A method of making the polymer of claim 1.

16. A method of making a polymer, the method comprising:
exposing a liquid containing reaction mixture to gaseous carbon monoxide, the reaction mixture comprising an alpha-olefin monomer, a catalyst, and a solvent.

17. The method of claim 16, wherein the alpha-olefine monomer is a linear C3 to C30 alpha-olefine monomer.

18. The method of claim 16, wherein the liquid containing reaction mixture is exposed to gaseous carbon monoxide at a pressure of 10 atm (1013 kPa) or less.

19. The method of claim 16, wherein the catalyst is a diimine late transition metal catalyst.

20. The method of claim 16, wherein the liquid containing reaction mixture comprises an additive and the additive comprises a tetraarylborate.
